(19) United States
(12) Patent Application Publication
(10) Pub. No.: US 2010/0056381 A1
(43) Pub. Date: Mar. 4, 2010

(54) POROUS BIOLOGICAL ASSAY SUBSTRATE AND METHOD AND DEVICE FOR PRODUCING SUCH SUBSTRATE

(75) Inventors: Ralph Kurt, Eindhoven (NL); Johan Frederik Dijksman, Eindhoven (NL); Anke Pierik, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/445,481

(22) PCT Filed: Oct. 24, 2007
(86) PCT No.: PCT/IB2007/054324

§ 371 Date: Apr. 14, 2009

(30) Foreign Application Priority Data
Oct. 30, 2006 (EP) 06123166.8

(51) Int. Cl. C40B 30/00; C40B 40/00; C40B 50/08; C40B 60/14

(52) U.S. Cl. 506/7; 506/13; 506/27; 506/40

(57) ABSTRACT

The invention provides a porous biological assay substrate suitable for detecting at least one analyte in a biological sample fluid. The substrate comprises one or more capture probes able to each specifically bind one target analyte. The average concentration of the capture probes in pores with a size larger than the O50 of the substrate pore size distribution is at least equal to the average concentration of the capture probes in pores with a size smaller than the O50. The substrate thereby shows improved binding efficiency. The invention also relates to a method and device for producing the biological assay substrate, and to a method for examining analyte fluids using the substrate.

### FIELD OF THE INVENTION

The present invention relates to the field of analysing biological sample fluids with respect to certain analytes and in particular to a porous biological assay substrate suitable for detecting at least one analyte in a biological sample fluid. In particular, the present invention permits an accurate and efficient analysis of biological sample fluids. The invention further relates to a method for producing a biological assay substrate by depositing a plurality of substances onto the substrate, and to a biological assay substrate obtainable by the method. The present invention also relates to a method for analysing a sample fluid with respect to one or more analyte molecules present in the sample fluid. The analyte may comprise any compound capable of binding to capture probes on the substrate, including target biological compounds, proteins, DNA, and so on. The method can be used for molecular diagnostic tests, e.g. for measuring the presence of infectious disease pathogens and resistance genes.

### BACKGROUND OF THE INVENTION

Arrays of capture probes on a substrate are used in biological test assays, for instance to examine analyte biological fluids, such as human blood or tissue samples, for the presence and/or concentration of certain bacteria, viruses and/or fungi. The capture probes have a selective binding capacity for a predetermined indicative factor, such as a protein, DNA or RNA sequence that belongs to a specific bacterium, virus or fungus. In the micro array technique, a set of specific capture probes, each of which being chosen in order to interact specifically (e.g. hybridize in the case of a DNA microarray) with one particular target biological compound, are immobilized at specific locations of a biosensor solid substrate, for instance by printing. Suitable probes may comprise bio-fluids containing the specific indicative factor, for instance a solution of a specific DNA sequence and/or antibody. After the substrate has been provided with the capture probes, the analyte fluid is forced to flow through the substrate, or forced to flow over the substrate. In order to be able to visualize the presence of an indicative factor in the analyte fluid, molecules of the analyte fluid may for instance be provided with fluorescent and/or magnetic labelling. In case of an ELISA (enzyme-linked immunosorbent assay) an enzyme is attached to the second antibody, instead of a radiolabel. An intensely colored or fluorescent compound is then formed by the catalytic action of this enzyme. The (labelled) molecules of the analyte fluid adhere to those capture probes of the substrate that have binding capacity for the molecule considered. This results in a detectable fluorescence on the spot the specific factor adheres to, at least when using fluorescent labelling. The captured molecules are typically read by illumination with a light source, and the fluorescent pattern recorded with the aid of a CCD camera for instance. The recorded pattern is a characteristic of the presence of a bacterium or a set of bacteria. By providing capture probes with different specificity for different factors, the array may be used to assay for various different factors at the same time. Using such arrays enables high-throughput screening of analyte fluids for a large amount of factors in a single run.

In order to ensure a good quality and efficiency of the high-throughput screening, it is desirable to bind as many labelled molecules of the analyte fluid as possible to those capture probes of the substrate that have binding capacity for the molecule considered. When binding of the molecules is insufficient (or hybridization in case of DNA strands), certain indicative factors may be missed and/or the fluorescent pattern may not be clearly distinguishable and/or may be deficient in some other sense. Although the known biological assay substrate as well as the method for producing such biological assay substrate yields a satisfactory binding efficiency, there is a need for a biological assay substrate as well as for a method for producing such biological assay substrate with improved binding efficiency. Moreover fast screening with increased speed of the analysis is desirable, especially in the field of clinical diagnostics.

### SUMMARY OF THE INVENTION

It is an object of the present invention to provide a porous biological assay substrate, including substrates for PCR and/or electrophoresis, with improved binding efficiency. It is a further object of the present invention to provide a method for producing such substrate by depositing a plurality of substances onto said substrate. It is a further object of the present invention to provide a device for producing such substrate which is able to deposit a plurality of substances onto said substrate. Another object of the present invention is to provide a method for examining analyte fluids, such as human blood or tissue samples, for the presence of certain bacteria, viruses and/or fungi, the method having an improved analysis efficiency.

The above objectives are accomplished by a porous biological assay substrate comprising one or more capture probes able to each specifically bind at least one target analyte, wherein the average concentration of the capture probes in pores with a size larger than the O₅₀ of the substrate pore size distribution is at least equal to the average concentration of the capture probes in pores with a size smaller than the O₅₀. Broadly speaking, by providing a substrate wherein on average the larger pores contain a higher concentration of capture probes, an increased binding efficiency of the substrate is obtained in comparison with the known biological assay substrates. Another advantage of the invention is that the analysis may be carried out faster, both for a flow-through and a flow-over configuration. This is especially so when an external pressure is applied.

In a preferred embodiment of the porous biological assay substrate according to the invention, the average concentration of the capture probes in pores with a size larger than the O₅₀ is at least twice the average concentration of the capture probes in pores with a size smaller than the O₅₀, even more preferred at least five times the average concentration of the capture probes in pores with a size smaller than the O₅₀, and most preferred at least ten times the average concentration of the capture probes in pores with a size smaller than the O₅₀.

The advantages of the invention are particularly notable for substrates having a broad pore size distribution. Particularly preferred substrate have a pore size distribution such that (O₉₀−O₁₀)≧2 O₅₀. A still more preferred biological assay substrate has a pore size distribution such that (O₉₀−O₁₀)≧5 O₅₀. Another preferred biological assay substrate has a pore size distribution such that (O₉₀−O₅₀)≧2 O₅₀ and (O₅₀−O₁₀)≧2 O₁₀.

According to the invention, a method for producing such biological assay substrate is also provided. In the method a plurality of capture molecule solutions are released onto the porous substrate, for instance from a print head of an ink jet printing device, and the substrate is provided with an inactivating medium having a lower evaporation rate and/or a higher boiling point than the solvent of the capture molecule solutions. Preferably the substrate is provided with the inactivating medium prior to releasing the capture probe molecule solutions onto the substrate. A particularly preferred method moreover comprises the further step of treating the substrate such that part of the inactivating medium is evaporated from the substrate prior to releasing the capture molecule solutions onto the substrate. By treating the substrate with an inactivating medium with the indicated characteristics, at least part of the pores of the substrate are (temporarily) blocked. The inactivating medium will however more easily be evaporated from the larger holes. When either forced or natural evaporation of the inactivating medium occurs, the smaller pores of the substrate will at least partly remain blocked. When applying the capture probe solutions to and into the substrate, the (blocked) smaller pores are to a lesser extent available for uptake of capture probe solution, which therefore preferably penetrates and adheres to the surface of the larger holes. Since an analyte fluid more easily penetrates the larger pores of the porous substrate, this causes the desired increased binding efficiency of the biological assay substrate of the present invention. This advantage is particularly notable in a flow-through configuration, where flow is less influenced by capillary forces than by pressure drop.

Any inactivating medium having a lower evaporation rate and/or a higher boiling point than the solvent of the capture molecule solutions may in principle be used in the method according to the present invention. Preferably the inactivating medium comprises a fluid having a lower evaporation rate and/or a higher boiling point than the solvent of the capture molecule solutions. Even more preferred is an inactivating liquid comprising an alkyl alcohol, ethers and esters derived there from, and/or a mixture thereof.

An additional advantage of the method and assay substrate according to the invention is that it requires less capture probes to be printed and/or needs less analyte fluid for a similar throughput than known hitherto. Both advantages reduce the cost of an analysis. Also, more fluid mixing and hybridization steps may be performed in order to improve the detection limit, thereby increasing analysis time. However according to a preferred embodiment of the invention the analysis time is decreased significantly compared to methods known in the art.

The invention further provides a device, and in particular an ink jet device for producing such biological assay substrate. The ink jet device according to the invention comprises a container for substances to be printed onto the substrate, the device comprising at least a print head, and mounting means for print head and substrate respectively, whereby the device comprises means for providing the substrate with an inactivating medium having an evaporation rate lower than that of the solvent of the capture molecule solutions. Particularly preferred embodiments of the device will be described in more detail below.

The present invention also provides a method for examining analyte fluids, such as human blood or tissue samples, for the presence of certain bacteria, viruses and/or fungi. In the method the analyte fluid is forced through or flows over a substrate according to the present invention. Flow-through is possible since the substrate material is porous. The binding of the target biological compound is the result of the free and/or forced flow of the sample fluid through the surface of the biological assay substrate, i.e. either from the lower surface to the upper surface or vice versa, and/or by a lateral flow from position A to position B on the substrate. To increase the chances for binding, flow-through may be repeated several times. The substrate of the present invention has the additional advantage that the number of such pumping cycles may be less for a similar binding efficiency.

As used herein, and unless stated otherwise, the term <<microarray assay>> designates an assay wherein a sample fluid, preferably a biological fluid sample (optionally containing minor amounts of solid or colloid particles suspended therein), suspected to contain target biological compounds is contacting (i.e. flowing over or flowing through) a biosensor solid substrate containing a multiplicity of discrete and isolated regions across a surface thereof, each of said regions having one or more probes applied thereto and each of said probes being chosen for its ability to bind specifically with a target biological compound. Notably, not every fluid deposited on the substrate needs to be a probe, i.e. has the ability to bind a specific analyte. The assay may also comprise other fluids, such as fluids used for calibration purposes, gridding markers, and so on. Such fluids may already comprise a label.

As used herein, and unless stated otherwise, the term <<analyte>> or <<target biological compound>> designates a biological molecular compound fixed as a goal or point of analysis. It includes biological molecular compounds such as, but not limited to, nucleic acids and related compounds (e.g. DNAs, RNAs, oligonucleotides or analogs thereof, PCR products, genomic DNA, bacterial artificial chromosomes, plasmids and the like), proteins and related compounds (e.g. polypeptides, peptides, monoclonal or polyclonal antibodies, soluble or bound receptors, transcription factors, and the like), antigens, ligands, haptens, carbohydrates and related compounds (e.g. polysaccharides, oligosaccharides and the like), cellular fragments such as membrane fragments, cellular organelles, intact cells, bacteria, viruses, protozoa, and the like.

As used herein, and unless stated otherwise, the term <<capture probe>> designates a biological agent being capable to bind specifically with a <<target biological compound>> or <<analyte>> when put in the presence of or reacted with said target biological compound, and used in order to detect the presence of said target biological compound. Probes include biological molecular compounds such as, but not limited to, nucleic acids and related compounds (e.g. DNAs, RNAs, oligonucleotides or analogs thereof, PCR products, genomic DNA, bacterial artificial chromosomes, plasmids and the like), proteins and related compounds (e.g. polypeptides, monoclonal antibodies, receptors, transcription factors, and the like), antigens, ligands, haptens, carbohydrates and related compounds (e.g. polysaccharides, oligosaccharides and the like), cellular organelles, intact cells, and the like. Probes may also include specific materials such as certain biopolymers to which target compounds bind.

As used herein, and unless stated otherwise, the term <<label>> designates a biological or chemical agent having at least one physical property (such as, but not limited to, radioactivity, optical property, magnetic property) detectable by suitable means so as to enable the determination of its spatial position and/or the intensity of the detectable physical property such as, but not limited to, luminescent molecules (e.g. fluorescent agents, phosphorescent agents, chemiluminescent agents, electroluminescent agents, bioluminescent agents and the like), colored molecules, molecules producing colors upon reaction, enzymes, magnetic beads, radioisotopes, specifically bindable ligands, microbubbles detectable by sonic resonance and the like.

These and other aspects of the present invention will be apparent from and elucidated with reference to the embodiment(s) described hereinafter, taken in conjunction with the accompanying drawings, which illustrate, by way of example, the principles of the invention.

### BRIEF DESCRIPTION OF THE DRAWINGS

In the figures:

FIG. 1 illustrates schematically a biological test array obtainable by printing capture probes onto as substrate according to the present invention;

FIG. 2 illustrates schematically a biological assay device provided with a porous substrate according to the present invention;

FIG. 3 represents a photograph of a porous substrate according to the present invention; and

FIG. 4 illustrates schematically an open pore size distribution of an embodiment of the porous substrate according to the invention.

### DETAILED DESCRIPTION OF EMBODIMENTS

The present invention will be described with respect to particular embodiments and with reference to certain drawings but the invention is not limited thereto but only by the claims. Any reference signs in the claims shall not be construed as limiting the scope. The drawings described are only schematic and are non-limiting. In the drawings, the size of some of the elements may be exaggerated and not drawn to scale for illustrative purposes. Where the term “comprising” is used in the present description and claims, it does not exclude other elements or steps. Where an indefinite or definite article is used when referring to a singular noun e.g. “a” or “an”, “the”, this includes a plural of that noun unless something else is specifically stated.

Furthermore, the terms first, second, third and the like in the description and in the claims, are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein.

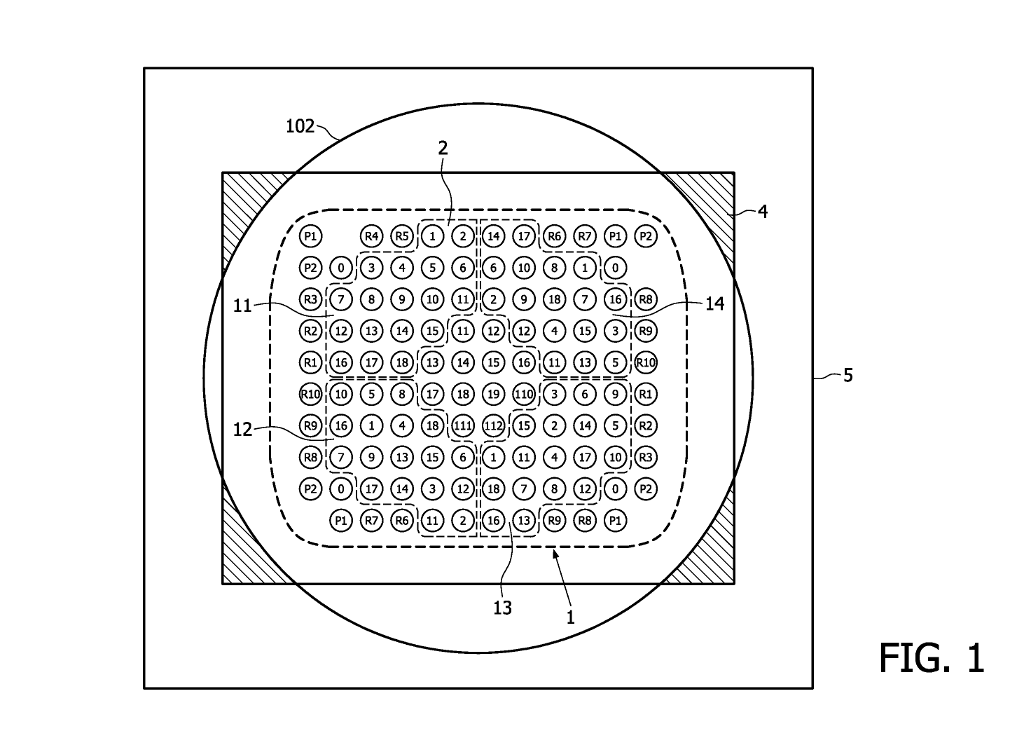

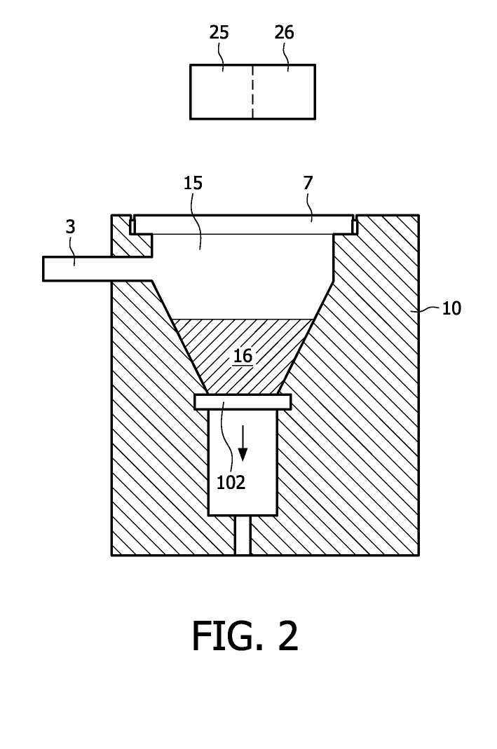

FIG. 1 shows a biological test array (1) obtained by depositing, preferably by ink jet printing, a plurality of capture probe spots (2) on a porous substrate (102), such as a membrane. According to the method of the invention, substrate (102) has been treated with an inactivating medium, and in this particular example with ethylene glycol, before printing the capture spots (2). In the example shown, the test array (1) is covered with a pattern of 128 spots (2) comprising 43 different bio-fluids, printed in a predefined pattern. The spots (2) are numbered, and each number represents a unique gene sequence or contains reference material. Note that the gene sequences occur in multiple duplicates in the array (1) on multiple mutually distant locations. The porous substrate (102) is fitted onto a supporting structure (4). Porous substrate (102) with the supporting structure or holder (4) is placed in a cartridge (5). A typical set-up is shown in FIG. 2. In a housing (10), a sample fluid (16) to be analysed is provided in a chamber (15) and pressure is applied at the inlet (3). This pressure forces the sample fluid (16) downwards through the porous solid substrate (102). A glass plate (7) permits an optical analysis of the solid substrate (102), if desired. Analyzing means (25) are provided for analyzing the solid substrate (102) for the presence of one or more target biological compounds. Said analysing means (25) may comprise a light source and an optical detection path, a lens, a filter, a digital camera etc in order to measure the optical fluorescence pattern. Other means (26) may be present, for instance for analyzing the solid substrates temperature, filled pore volume, and other desirably monitored parameters. The dashed line indicates that means (25) and (26) may eventually be combined into a single apparatus (e.g. an optical detection means such as a CCD camera or any other kind of optical detection device of which a camera is only one possibility. Other possibilities include photodetectors or a microscope). Provision may be made to cycle the sample fluid (16) a number of times through chamber (15) and substrate (102). Preferably, the substrate (102) is continuously or intermittently but regularly wetted with the sample fluid (16). The analyte fluid is analysed for the presence of certain bacteria, viruses and/or fungi, by forcing it through the porous substrate. The free and/or forced flow of the sample fluid through the surface of the biological assay substrate, i.e. either from the lower surface to the upper surface or vice versa brings the analyte fluid in contact with the capture probes, which allows binding of the target biological compound to these capture probes able to bind with it. More in particular, the sample fluid (such as a PCR product) containing the different gene sequences characteristic for the DNA of different bacteria is brought into contact with the porous substrate (102) comprising the array of spots (2). Different DNA types (gene sequences) adhere to the different printed capture probes. In the embodiment shown in FIG. 1, different spots are visualised. The numbers 1 to 18 represent 9 different pathogens and 9 resistances. For reliability of the measurement, the same bio selective capture material may be printed in four different quadrants (11, 12, 13, 14) of membrane (102). In each of the quadrants (11, 12, 13, 14), spots of the same number have different neighbouring spots, preventing that less intense spots (2) are not detected because of overexposure from adjacent spots (2). Intensity calibration spots (R1 to R10) may be printed on the membrane (102), as well as four spots (D) in the corners of the membrane for intensity calibration distribution over membrane (102). PCR control spots (P1, P2) are also printed to validate the proper DNA-amplification by means of PCR.

A biological test array according to the invention preferably comprises a total amount of about 130 spots, as shown in FIG. 1, but may comprise many more spots, for instance more than 1000. Typical diameters of the spots are below 100-300 μm, but may be even lower, and they are positioned in a pattern with a pitch of typically less than 400 μm, preferably less than 300 μm. Said spots are preferably printed in a periodic pattern e.g. in squared, rectangular or hexagonal configuration. Also a large amount of different bio-fluids (preferably 100 or more) are typically printed onto membrane (102).

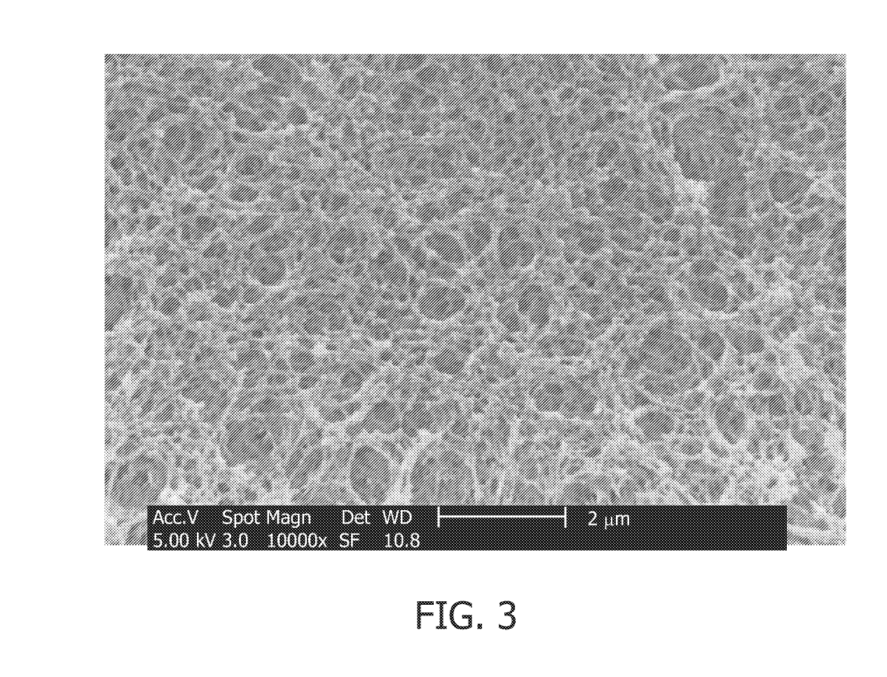

According to the invention a porous biological assay substrate is provided comprising one or more capture probes able to each specifically bind one target analyte, wherein the average concentration of the capture probes in pores with a size larger than the O₅₀ of the substrate pore size distribution is at least equal to the average concentration of the capture probes in pores with a size smaller than the O₅₀. Broadly speaking, by providing a substrate wherein on average the larger pores contain a higher concentration of capture probes, an increased binding efficiency of the substrate is obtained in comparison with the known biological assay substrates. Biological assay substrates are usually made from porous material, having internal pores with a distribution of pore sizes. FIG. 3 shows a micrograph of a suitable biological assay substrate, having a preferred broad pore size distribution. From FIG. 3 is easily inferred that a typical porous substrate comprises open pore sizes ranging from a few nanometers (nm) to micrometers (μm). When providing the known membrane with capture probes, said probes preferably attach to the inner surfaces of the smaller pores, due to capillary forces, evaporation of the solvent and due to surface tension effects a.o. Flow transport of the analyte fluid, especially in the case of a wet membrane, however occurs more easily through the larger pores, since resistance to flow through these pores is lower. Since on average the larger pores of the known substrate comprise less capture probe molecules, the probability for specific binding of capture probe molecules with the analyte fluid will be lower than expected, and hence a decreased binding efficiency will occur. The inventors have devised a method to produce, for the first time, a substrate wherein on average the larger pores comprise more capture probe molecules than the smaller pores, and hence an increased binding efficiency and screening method is obtained.

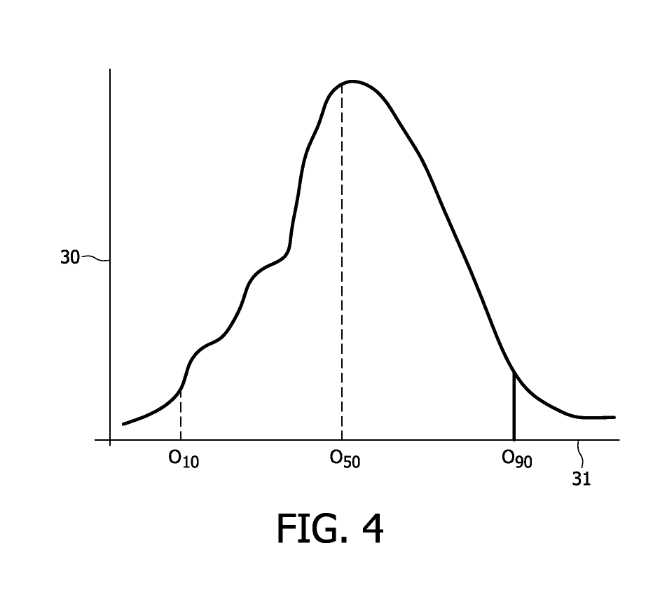

In the context of the present invention, and with reference to FIG. 4, dimensions O₁₀, O₅₀ and O₉₀ are characteristic sizes of the pore size distribution. As indicated in FIG. 4, the pore size distribution is represented by a graph of some measure 30, represented on the y-axis, and representative of the amount, or the relative surface, or volume fraction of pores of a certain size, against the open pore size 31, represented on the x-axis. Measure 30 of course depends on the particular measuring technique used to assess pore size distribution. Characteristic dimensions O10, O50 and O90 are defined such that 10 vol. % of the pores is smaller than or equal to O₁₀, 50 vol. % of the pores is smaller than or equal to O₅₀, and 90 vol. % of the pores is smaller than or equal to O₉₀. Several methods known per se may be used in assessing the porosity and pore size distribution of the porous substrates. Well known methods to measure and/or quantify the pore size and pore size distribution include imaging analysis techniques, gas adsorption as well as intrusion methods, such as mercury intrusion methods. The proper method to use depends on average pore size besides other factors, mercury intrusion for instance being the more appropriate method for measuring larger pores. These methods are well known and one skilled in the art will be able to select without any difficulties the appropriate measuring method. The concentration of capture probes in the pores can also be assessed by methods, well known in the art. A suitable method includes the combined use of imaging techniques (optical and/or electron microscopy) with standard labelling methods. Typically using fluorescent or radioactive labels or labels comprising metallic nanoparticles allows to detect the capture probes and their average concentration by a (confocal) fluorescence microscope, by a X-ray image plate, and/or under an electron microscope, respectively.

In a preferred embodiment of the porous biological assay substrate the average concentration of the capture probes in pores with a size larger than the O₅₀ is at least twice the average concentration of the capture probes in pores with a size smaller than the O₅₀. An even more preferred embodiment of the porous biological assay substrate is characterized in that the average concentration of the capture probes in pores with a size larger than the O₅₀ is at least five times the average concentration of the capture probes in pores with a size smaller than the O₅₀. As will become apparent herein below, the average concentration of the capture probes in the larger pores may be influenced by the volumetric percentage of the smaller pores that are (temporarily) not accessible when providing the substrate with the capture probe solution.

The observed improvement in binding efficiency of the substrate of the invention when compared to the state of the art substrate is larger when the substrate per se has a relatively broad pore size distribution. A particularly preferred porous biological assay substrate therefore has a pore size distribution such that (O₉₀−O₁₀)≧2 O₅₀, and even more preferred such that (O₉₀−O₁₀)≧5 O₅₀. Another preferred biological assay substrate has a pore size distribution such that (O₉₀−O₅₀)≧2 O₅₀ and (O₅₀−O₁₀)≧2 O₁₀.

Suitable porous substrates may include a network having a plurality of pores, openings and/or channels of various geometry and dimensions. Porous substrates may be nanoporous or microporous, i.e. the average size of the pores, openings and/or channels (characterized by the O₅₀ value) may suitably be comprised between about 0.05 μm and about 10.0 μm. In one embodiment this average pore size may be between 0.1 μm and 3.0 μm. In another embodiment, the average pore size may be between about 0.2 and 1 μm. The term “porosity” usually means or includes the ratio of the volume of all the pores or voids in a material with respect to the volume of the whole material. In other words, porosity is usually the proportion of the non-solid volume to the total volume of material. In the sense of the present invention, the term “open porosity” (also called effective porosity) especially means or includes the fraction of the total volume in which fluid flow is effectively taking place. Since the open porosity alone is of importance in the context of the present application (closed pores are not accessible to capture probe and sample fluids) the terms “porosity” and “open porosity” are used interchangeably in the present application, unless explicitly noted otherwise. In the sense of the present invention porosity is especially a fraction between 0 vol. % and 100 vol. %. According to a preferred embodiment said porosity is ranging from 20 vol. % to 98 vol. %, more preferably from 30 vol. % to 80 vol. % and most preferably from 40 vol. % to 70 vol. %.

According to a preferred embodiment of the present invention, the porous substrate material is chosen from the group comprising

amorphous polymers, preferably from the group comprising PC (polycarbonate), PS (polystyrene), PMMA (polymethylmethacrylate), polyacrylates, polyethers, cellulose ester, cellulose nitrate, cellulose acetate, cellulose or mixtures thereof,

semicrystalline polymers, preferably from the group comprising PA (polyamide=nylon materials), PTFE (polytetrafluoroethylene), polytrifluoroethylene, PE (polyethylene), PP (polypropylene), or mixtures thereof,

rubbers, preferably from the group comprising PU (polyurethane), polyacrylates, silane based polymers such as PDMS (polydimethylsiloxane) or mixtures thereof,

gels (=polymer networks with fluid solvent matrix), preferably from the group comprising agarose gel, polyacrylamide gel or mixtures thereof

metals (such as aluminum, tantalum, titanium), alloys of two or more metals, doped metals or alloys, metal oxides, metal alloy oxides or mixtures thereof

or mixtures thereof. These materials have shown to be suitable materials within the present invention.

According to an embodiment of the present invention, the inner surface area of the solid, porous substrate material is by a factor X larger than the size of this area, whereby the factor X is >100. According to another embodiment, the factor X is >1000, according to an alternative embodiment X is >10000, and according to yet another embodiment, X is >100000.

The thickness of the substrate is not a limiting feature of this invention and it can vary from about 50 nm up to about 3 μm or higher, e.g. up to 1 mm. If the membrane is free-standing, e.g. in the case of a flow-through device (as described above) the substrate thickness can range from 1 μm to hundreds of μm, e.g. from 20 μm to 400 μm, or from 50 μm to 200 μm.

The shape and or size of the substrate, e.g. the membrane, are not considered to be limiting features of the present invention. It may be circular, e.g. with a diameter ranging between about 3 and 15 mm, but any other substrate shape (rectangular, square, oval, . . . ) and/or size may also be suitable.

The probes used for the present invention should be suitably chosen for their affinity to the target biological compounds or to the relevant modifications of said target biological compounds suspected to be present in the sample to be analyzed. For example, if the target biological compounds are DNA, the probes can be, but are not limited to, synthetic oligonucleotides, analogues thereof, or specific antibodies. A non-limiting example of a suitable modification of a target biological compound is a biotin substituted target biological compound, in which case the probe may bear an avidin functionality.

In a particular embodiment of the present invention, several different probes are deposited into and/or onto the substrate. In a more specific embodiment, multiple different probes are spotted in an array fashion on physically distinct locations along one surface of said solid substrate in order to allow measurement of different target biological compounds in parallel. This embodiment is usually named a micro-array.

In order to more easily support subsequent detection and identification, one or more additional spots (e.g. for intensity calibration and/or position detection) can be spotted as well onto the surface of the substrate material. Spotting can be suitably effected by any methods known in the art such as, but not limited to, ink-jet printing, piezoelectric spotting, robotic contact printing, micropipetting, and the like. Following spotting, the probes become immobilized onto the surface of the substrate material, either spontaneously due to the substrate (e.g. membrane) inherent or acquired (e.g. via activation) properties, or through an additional physical treatment step (such as, but not limited to, cross-linking, e.g. through drying, heating, a temperature treatment step, or through exposure to a light source).

According to the invention, a method for producing a biological assay substrate, wherein a plurality of capture molecule solutions are released from at least one print head onto the porous substrate is provided, the method comprising the step of providing the substrate with an inactivating medium having a lower evaporation rate and/or a higher boiling point than the solvent of the capture molecule solutions. By treating the substrate with an inactivating medium with the indicated characteristics, an improved binding efficiency, and consequently an improved screening method is obtained.

Although the inventors are ignorant about the precise reason for the improvement, the following tentative explanation is offered. Biological assay substrates are usually made from porous material, having internal pores with a distribution of pore sizes. When providing the known membrane with capture molecule solutions, it is plausible that the capture probes preferably attach to the inner surfaces of the smaller pores. Indeed, the capture molecule solvent is thought to evaporate first from the larger pores, thereby locally increasing the concentration of capture probes in the smaller pores. In particular when the membrane is neutral in charge, a driving force that would cause the capture probes to adhere to the membrane surface is absent. During evaporation of the solvent of the capture molecule solution, the dissolved capture molecules increasingly agglomerate in the remaining fluid until they form a gel. Moreover, due to capillary forces and surface tension, the remaining fluid has a preference for the smallest pores. Gelation, sedimentation (of the molecules to the pore walls) and ultimately crystallization and/or immobilization therefore preferably take place in the smallest pores. Flow transport of the analyte fluid however occurs preferably through the larger pores. Since on average the larger pores comprise less capture probe molecules, a decreased probability for specific binding of capture probe molecules with the analyte fluid during flow-through will result, and hence a decreased binding efficiency. According to the invention, by treating the substrate with an inactivating medium having an evaporation rate lower than that of the solvent of the capture molecule solution, it is believed that the smaller pores of the substrate are effectively (at least partly and/or temporarily) filled or blocked by the inactivating medium, and remain so for a prolonged time, and preferably at least until providing the substrate with the capture molecule solution and/or forcing the analyte fluid through the membrane.

In a preferred method according to the invention, the substrate is provided with the inactivating medium prior to releasing the capture molecule solutions onto the substrate. Although not essential to the method according to the invention pretreating the substrate with the inactivating medium generally yields a higher binding efficiency than treating the substrate with the inactivating medium during or after releasing the capture molecule solutions onto the substrate.

In another preferred method according to the invention, the substrate is provided with the inactivating medium within a time frame of between 5 seconds to 90 minutes before releasing the capture molecule solutions onto the substrate. Even more preferred is a time frame of between 30 seconds to 60 minutes. Most preferred is a time frame of between 1 minute to 30 minutes.

According to the invention any medium that evaporates slower or boils at a higher temperature than the solvent of the capture molecule solution may be used in the method according to the invention. The medium may be gaseous or fluid. In a preferred embodiment of the method, the inactivating medium comprises a fluid. Such fluid may easily be applied to the substrate by any suitable method, such as by printing techniques or by dip coating. Particularly suitable inactivating liquids comprise an alkyl alcohol compound, ethers and/or esters derived there from, or mixtures thereof. Suitable examples include for instance ethylene glycol, diethylene glycol, triethylene glycol, tetraethylene glycol and polyethylene glycol in general, and/or any mixture thereof with water. Also (poly)propylene glycol, propylene glycol, dipropylene glycol, etc. may advantageously be used, the latter being less polar solvents compared to polyethylene glycol for instance, which is polar. Other suitable examples include dibutylterephthalate or dioctylphthalate. Some inactivating liquids may require an additional washing step.

When carrying out the preferred method according to the invention, the smaller pores of the substrate are at least partly filled with a (temporary) inactivating medium directly prior to the step of actual printing of the capture molecules. The inactivating medium is chosen such that it evaporates slower, and preferably significantly slower than the solvent used for printing the capture molecules, or evaporates at a higher temperature (higher boiling point). The capture molecules solution therefore preferably employs a solvent having a better solubility than the inactivating medium. Within the context of the present invention, a first evaporation rate is considered significantly lower than a second evaporation rate when the first evaporation rate is at least 10% lower than the second evaporation rate, preferably at least 30% lower, and most preferably at least 50% lower. Although the method according to the invention is not limited thereto, most capture molecule solutions used at present are aqueous solutions. This means that suitable inactivating media in this case evaporate at a slower rate than water at the same conditions of temperature and pressure. According to general physical principles, capillary forces are inversely proportional to pore radius, and therefore are largest in the smaller pores. Resistance to flow however is inversely proportional to pore radius to the fourth power, and therefore rises much faster with decreasing pore diameter than capillary forces. It will therefore take some time to fill the pores of the substrate with inactivating medium, and especially the smaller pores. A compromise therefore exists between the time of treatment of the substrate with the inactivating medium, and the volumetric percentage (vol.-%) of pores that have been filled with the inactivating medium. The longer the inactivating liquid resides or comes into contact with the porous substrate, the more pores will eventually become filled with inactivating liquid.

A preferred method according to the invention is characterized in that the substrate is provided with the inactivating medium such that about 50 vol.-% of the pores of the substrate are filled with the inactivating medium. Preferably more than 80 vol % of the pores are filled with the inactivating medium. In an even more preferred embodiment of the method the substrate is provided with the inactivating medium such that substantially all open pores of the substrate are filled with the inactivating medium.

In order to accelerate the process even further an additional (optional) treatment is performed according to the invention, such as washing, a temperature treatment step, light exposure or an exposure to a gas flow.

Preferably after at least part of the pores of the porous substrate has been filled with the inactivating medium, the substrate is provided with an array of capture probes of suitable bio-fluids. According to the invention, a plurality of capture molecule solutions are thereto released from at least one print head onto the porous substrate, using an ink jet device suitable for this purpose. When droplets of the capture molecule solutions hit the surface of the substrate, at least part of the droplet material is taken up by the porous structure of the substrate, i.e. enters at least some of the pores of the substrate.

A particularly preferred method according to the invention comprises a further step of subjecting the substrate to a treatment such that part of the inactivating medium is evaporated from the substrate prior to releasing the capture molecule solutions onto the substrate. The treatment may for instance comprise applying a stream of air and/or other gaseous medium under-pressure. Application of such stream causes the larger pores to open up first, i.e. to release any substance—such as the inactivating medium—present therein. Indeed, capillary forces are lowest for these (larger) pores. After at least some of the inactivating liquid has been evaporated, the capture probes are printed onto the substrate. Due to the differences in evaporation rate between solvent of the capture molecule solution and inactivating medium, the capture molecules preferably adhere and/or become adhered to the inner surface of the larger pores. Since the analyte also preferably passes the large pores when it is pumped through/along the substrate, this measure improves hybridization efficiency. The method of the present invention provides for improved control over the analyte fluid distribution over and/or in the porous substrate. The method moreover enhances the capture probability of the bio-fluid flow by matching the pores (based on a size selection) where capture probes are preferably located with the pores wherein the analyte fluid is preferably flowing.

In the method according to the invention any substrate having any degree of porosity may in principle be used. Preferred substrates include porous substrates with a broad pore size distribution. Even more preferred substrates include those having porosity morphologies comprising interconnected and/or multidirectional pores. Such preferred substrates generally exhibit differences in flow of a certain medium there through, depending on whether the substrate and the medium are dry-wet, wet-wet, or wet-dry respectively. A preferred species of a substrate comprises a membrane of a suitable polymer. Multi- and unidirectional porous membranes are known in the art, but not in connection with the method according to the invention, and are commercially available. Moreover charged and supercharged, and/or chemically functionalized membranes are preferably used according to the invention.

The invention also relates to an ink jet device for producing such biological assay substrate and to a biological assay substrate obtainable by the method. The ink jet device according to the invention comprises mounting means for print head and substrate respectively, whereby the device comprises means for providing the substrate with an inactivating medium having an evaporation rate lower than that of the solvent of the capture molecule solutions. In a preferred embodiment, the means for providing the substrate with an inactivating medium comprise a print head. A still more preferred ink jet device further comprises means to measure the amount of inactivating medium present in the substrate, mostly preferred the vol.-% of pores in the substrate, filled with inactivating medium. Moreover said device comprises, according to a preferred embodiment, means of controlling the evaporation rate of said printed fluids, especially of said inactivating fluid and said print solvent of the capture probe fluid, by controlling local temperature, gas flow and geometry on top of said substrate.

The substance, comprising biologically active molecules, is preferably dissolved in a solution. This solution is typically a fluid, like water or different types of alcohol, and may also contain small amounts of additives, for instance to adjust the surface tension, viscosity or boiling point, in order to optimise print characteristics, spot formation, shelf life of the bio-fluids, and so on.

While the present invention has been illustrated and described with respect to particular embodiments and with reference to certain drawings and foregoing description, such illustration and description are to be considered illustrative or exemplary and not restrictive. The invention is not limited to the described embodiments. Instead, the ink jet printer according to the present invention can be used for any precision placement of droplets onto membranes. It is particularly suited for the production of biosensors for molecular diagnostics. Diagnostics include rapid and sensitive detection of proteins and nucleic acids in complex biological mixtures, such as blood or saliva, for on-site testing and for diagnostics in centralized laboratories. Other applications are in medical (DNA/protein diagnostics for cardiology, infectious disease and oncology), food, and environmental diagnostics.

1. A porous biological assay substrate suitable for detecting at least one analyte in at least one sample fluid, the substrate comprising one or more capture probes able to each specifically bind at least one target analyte, wherein the average concentration of the capture probes in pores with a size larger than the O₅₀ of the substrate pore size distribution is at least equal to the average concentration of the capture probes in pores with a size smaller than the O₅₀.

2. A porous biological assay substrate according to claim 1, wherein the average concentration of the capture probes in pores with a size larger than the O₅₀ is at least twice the average concentration of the capture probes in pores with a size smaller than the O₅₀.

3. A porous biological assay substrate according to claim 1, wherein the average concentration of the capture probes in pores with a size larger than the O₅₀ is at least five times the average concentration of the capture probes in pores with a size smaller than the O₅₀.

4. A porous biological assay substrate according to claim 1, wherein the pore size distribution is such that (O₉₀−O₁₀)≧2 O₅₀.

5. A porous biological assay substrate according to claim 4, wherein the pore size distribution is such that (O₉₀−O₁₀)≧5 O₅₀.

6. A porous biological assay substrate according to claim 1, wherein the porosity ranges from 20 vol. % to 98 vol. %.

7. A porous biological assay substrate according to claim 6, wherein the porosity ranges from 30 vol. % to 80 vol. %.

8. A porous biological assay substrate according to claim 6, wherein the porosity ranges from 40 vol. % to 70 vol. %.

9. Method for producing a biological assay substrate, wherein a plurality of capture probe molecule solutions are released from at least one print head onto the porous substrate, the method comprising the step of providing the substrate with an inactivating medium having an evaporation rate lower than that of the solvent of the capture probe molecule solutions.

10. Method according to claim 9, wherein the substrate is provided with the inactivating medium prior to releasing the capture probe molecule solutions onto the substrate.

11. Method according to claim 10, wherein the substrate is provided with the inactivating medium within a time frame of between 5 seconds to 90 minutes before releasing the capture molecule solutions onto the substrate.

12. Method according to claim 11, wherein said time frame is between 30 seconds and 60 minutes.

13. Method according to claim 11, wherein said time frame is between 1 minute and 30 minutes.

14. Method according to claim 9, wherein the substrate is provided with the inactivating medium such that about 50 vol.-% of the open pores of the substrate are filled with the inactivating medium.

15. Method according to claim 14, wherein about 80 vol.-% of the open pores of the substrate are filled with the inactivating medium.

16. Method according to claim 14, wherein substantially all open pores of the substrate are filled with the inactivating medium.

17. Method according to claim 9, comprising the further step of subjecting the substrate to a treatment such that part of the inactivating medium is evaporated from the substrate prior to releasing the capture molecule solutions onto the substrate.

18. Method according to claim 9, wherein the inactivating medium comprises a liquid.

19. Method according to claim 18, wherein the inactivating liquid comprises an alkyl alcohol, or a mixture thereof.

20. Method according to claim 9, wherein the capture molecule solutions comprise a biochemical reactant and/or an oligonucleotide, and/or a polypeptide and/or a protein, and/or a cell, and/or (parts of) RNA/PNA/LNA.

21. A porous biological assay substrate obtainable by the method of claim 9 comprising one or more capture probes able to each specifically bind one target analyte, wherein the average concentration of the capture probes in pores with a size larger than the O₅₀ of the substrate pore size distribution is at least equal to the average concentration of the capture probes in pores with a size smaller than the d₅₀.

22. Method for examining analyte fluids, such as human blood or tissue samples, for the presence of certain bacteria, viruses and/or fungi, wherein the analyte fluid is forced through or over a substrate according to claim 1.

23. Method for examining analyte fluids, such as human blood or tissue samples, for the presence of certain bacteria, viruses and/or fungi, wherein the analyte fluid is forced through or over a substrate, obtained by a method according to claim 9.

24. Ink jet device for producing a biological assay substrate by releasing a plurality of substances onto the substrate, the device comprising at least a print head, and mounting means for print head and substrate respectively, whereby the device comprises means for providing the substrate with an inactivating medium having an evaporation rate lower than that of the solvent of the capture molecule solutions.

25. Ink jet device according to claim 24, wherein the means for providing the substrate with an inactivating medium comprise a print head.

26. Ink jet device according to claim 24, wherein the device further comprises means to measure the amount of inactivating medium present in the substrate.

27. Ink jet device according to claim 24, wherein the device further comprises means to measure the vol.-% of pores in the substrate, filled with inactivating medium.

28. Ink jet device according to claim 24, wherein the device further comprises means for subjecting the substrate to a treatment such that part of the inactivating medium is evaporated from the substrate.

29. Ink jet device according to claim 28, wherein the device further comprises means to control the evaporation rate of the inactivating medium and/or the capture probe solvent.
